(19) United States
(12) Patent Application Publication
(10) Pub. No.: US 2023/0306112 A1
(43) Pub. Date: Sep. 28, 2023

(54) APPARATUS AND METHOD FOR DETECTION AND CLASSIFICATION OF MALICIOUS CODES BASED ON ADJACENCY MATRIX

(71) Applicant: Foundation of Soongsil University-Industry Cooperation, Seoul (KR)

(72) Inventors: Souhwan JUNG, Seoul (KR); VuLong NGUYEN, Seoul (KR); Hyunseok SHIM, Seoul (KR)

(73) Assignee: Foundation of Soongsil University-Industry Cooperation, Seoul (KR)

(21) Appl. No.: 18/020,904

(22) PCT Filed: Nov. 26, 2020
(86) PCT No.: PCT/KR2020/016939

§ 371 Date: Feb. 10, 2023

(30) Foreign Application Priority Data
Nov. 19, 2020 (KR) 10-2020-0155901
Nov. 25, 2020 (KR) 10-2020-0160107

(51) Int. Cl. G06F 21/56; G06F 21/55

(52) U.S. Cl. CPC G06F 21/563; G06F 21/554

(57) ABSTRACT

Provided is an apparatus for detecting and classifying malicious code. The malicious code detection and classification apparatus comprise a graph-generating unit configured to generate graph information from source data including a plurality of nodes corresponding to APIs included in the source data and one or more edges connecting between the plurality of nodes; a matrix-generating unit configured to generate an adjacency matrix between the APIs included in the source data using the graph information; and a machine-learning unit configured to detect malicious code included in the source data using the adjacency matrix as an input value for a machine-learning-based analysis model. According to the malicious code detection and classification apparatus, since a call graph between APIs is converted into an adjacency matrix, in which each row and each column are APIs, and used as an input value for a machine-learning-based analysis model, it has the advantage of being able to detect malicious code with a high detection rate and accuracy compared to the prior art.

### Technical Field

The present disclosure relates to a malicious code detection and classification apparatus, method and a computer program for the same. More specifically, the present disclosure relates to a technology for detecting malicious code by analyzing the connection relationship between APIs (Application Programming Interfaces) included in the source code of the program through machine-learning based on the adjacency matrix.

### BACKGROUND ART

Malicious code refers to software designed to cause damage to a computing device or the computer network related thereto and including viruses, worms, trojans, ransomware, adware, spyware and malvertising. If there is malicious code inside the computer, since the data stored on the device may be damaged or it may cause economic damage to the user by stealing the user's personal information, it is very important to constantly detect the presence of malicious code and remove it proactively.

Recently, as the use of smartphones has rapidly spread, malicious code is often distributed in the form of an app for the Android operating system, and research on methods for finding out whether certain source code in these files is malicious code is being conducted.

For example, Hasegawa, C. and Iyatomi, H., “One-dimensional convolutional neural networks for Android malware detection.” (IEEE 14th International Colloquium on Signal Processing & Its Applications (CSPA), 2018, pp. 99-102) discloses that analysis is performed by converting a specific part of the APK file into a short string and applying a convolutional neural network (CNN) to it. This method has the advantage of fast processing speed, but a small amount of string cannot represent the corresponding app, and even if it is a malicious app, most of it is composed of benign, that is, non-malicious strings, so It is difficult to detect.

As another example, Huang, N. et al., “Deep Android Malware Classification with API-Based Feature Graph” (18th IEEE International Conference On Trust, Security And Privacy In Computing And Communications/13th IEEE International Conference On Big Data Science And Engineering (TrustCom/BigDataSE), IEEE, 2019) discloses that training and classification are performed by applying a CNN to a feature graph based on an API (Application Programming Interface). However, the feature graph used in this method has a limitation that is not sufficient to represent the operation of the app itself.

As another example, “Graph embedding based familial analysis of android malware using unsupervised learning” co-authored by Fan, M. and 6 others (2019 IEEE/ACM 41st International Conference on Software Engineering (ICSE), IEEE, 2019) discloses that detecting malicious code by converting whether graphs for API calls match to similarity calculations that are easy in vector calculation. However, this study is structured to identify APIs using a database that is out of maintenance, so there is a problem of inappropriate use.

As another example, “A Graph-Based Feature Generation Approach in Android Malware Detection with Machine Learning Techniques” co-authored by Liu, Xiaojian and 2 others (Mathematical Problems) in Engineering, 2020) discloses identifying diagrams of API calls with security-sensitive broadcast events, security-sensitive permissions, and related contexts. However, this study is based on a technique that is not currently used in mapping permissions and APIs, and the proposed mapping has limitations in not considering the path sensitivity of API flows.

As a result, technology capable of detecting malicious code with a high detection rate and accuracy based on an API used in a program has not existed in the past.

### PRIOR ART

### Patent Literature

Korean Patent Application Publication No. 10-2012-0105759

### DISCLOSURE

### Technical Problem

According to one aspect of the present invention, a malicious code detection and classification apparatus and method capable of detecting malicious code by converting the connection relationship between APIs (Application Programming Interfaces) included in the source code of the program into an adjacency matrix and using it as an input value for a machine-learning-based analysis model, and a computer program for the same may be provided.

### Technical Solution

The apparatus for detecting and classifying malicious code according to an embodiment of the present invention comprises a graph-generating unit configured to generate graph information from source data including a plurality of nodes corresponding to APIs included in the source data and one or more edges connecting between the plurality of nodes; a matrix-generating unit configured to generate an adjacency matrix between the APIs included in the source data using the graph information; and a machine-learning unit configured to detect malicious code included in the source data using the adjacency matrix as an input value for a machine-learning-based analysis model.

In one embodiment, the graph information is text data written in a graph modeling language (GML).

In one embodiment, the adjacency matrix is a two-dimensional matrix containing one or more columns corresponding to the API included in the source data and one or more rows corresponding to the API included in the source data.

In one embodiment, the matrix-generating unit configured to generate the adjacency matrix by updating the adjacency matrix in response to an API that is executed as the APIs included in the source data are sequentially executed being associated with another API.

In one embodiment, the machine-learning unit comprises a filter unit configured to activate a region corresponding to APIs connected to each other in the adjacency matrix; and an analysis unit configured to classify the adjacency matrix using the activated region as an input value for the machine-learning-based analysis model.

In one embodiment, the analysis unit is further configured to perform to detect the malicious code by a convolution neural network (CNN) algorithm using the activated region as an input image.

The method for detecting and classifying malicious code according to an embodiment of the present invention comprises generating, by a malicious code detection and classification apparatus, graph information from source data including a plurality of nodes corresponding to APIs included in the source data and one or more edges connecting between the plurality of nodes; generating, by the malicious code detection and classification apparatus, an adjacency matrix between the APIs included in the source data using the graph information; and detecting, by the malicious code detection and classification apparatus, malicious code included in the source data using the adjacency matrix as an input value for a machine-learning-based analysis model.

In one embodiment, generating the adjacency matrix comprises generating, by the malicious code detection and classification apparatus, a two-dimensional matrix containing one or more columns corresponding to the API included in the source data and one or more rows corresponding to the API included in the source data.

In one embodiment, generating the adjacency matrix comprises updating, by the malicious code detection and classification apparatus, the adjacency matrix in response to an API that is executed as the APIs included in the source data are sequentially executed being associated with another API.

In one embodiment, detecting the malicious code included in the source data comprises activating, by the malicious code detection and classification apparatus, a region corresponding to APIs connected to each other in the adjacency matrix by a filter; and classifying, by the malicious code detection and classification apparatus, the adjacency matrix using the activated region as an input value for the machine-learning-based analysis model.

In one embodiment, classifying the adjacency matrix is performed by a CNN algorithm using the activated region as an input image.

A computer program according to one embodiment is combined with hardware to execute the malicious code detection and classification method according to the above-described embodiments, and may be stored in a computer-readable medium.

### ADVANTAGEOUS EFFECTS

According to an apparatus and method for detecting and classifying malicious code according to an aspect of the present invention, malicious code in the source data can be detected based on the learning result of the API appearance frequency in malicious code by generating a call graph between application programming interfaces (APIs) from source data, converting it to an adjacency matrix, In which each row and column are APIs, and analyzing it through a machine-learning-based analysis model.

According to the apparatus and method for detecting and classifying malicious codes according to one aspect of the present invention, malicious codes can be detected with a very high detection rate, and furthermore, malicious codes can be detected with high accuracy, such as 100% in the case of some malicious code families.

### DESCRIPTION OF DRAWINGS

These and/or other aspects will become apparent and more readily appreciated from the following description of the embodiments, taken in conjunction with the accompanying drawings in which:

FIG. 1 is a schematic block diagram showing the configuration of a malicious code detection and classification apparatus according to an embodiment;

FIG. 2 is a flowchart illustrating each step of a malicious code detection and classification method according to an embodiment;

FIG. 3 is a call graph showing API calls of source data analyzed by a malicious code detection and classification method according to an embodiment;

FIG. 4 is an image showing an adjacency matrix generated using the graph information shown in FIG. 3; and

FIG. 5 is a conceptual diagram for describing a process of classifying malicious codes by a convolution neural network (CNN) in a malicious code detection and classification method according to an embodiment.

### DETAILED DESCRIPTION OF EMBODIMENTS

Hereinafter, with reference to the drawings, the embodiments of the present disclosure is described in detail.

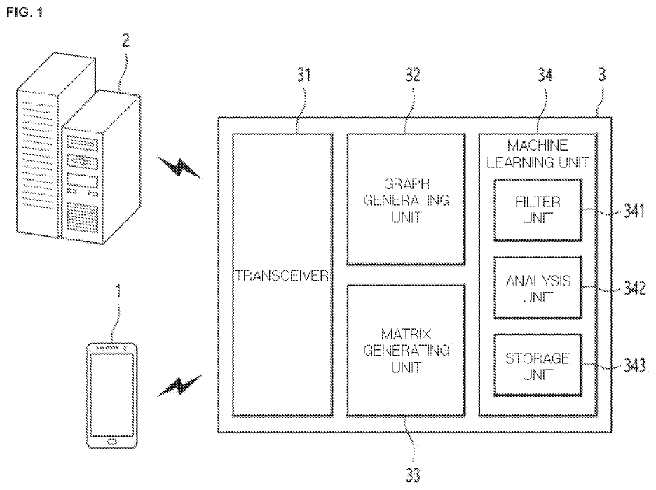

FIG. 1 is a schematic block diagram showing the configuration of a malicious code detection and classification apparatus according to an embodiment.

Referring to FIG. 1, the apparatus for detecting and classifying malicious code 3 according to the present embodiment includes a graph-generating unit 32, a matrix-generating unit 33, and a machine-learning unit 34. Also, in one embodiment, the malicious code detection and classification apparatus 3 may further include a transceiver 31.

Each unit of the malicious code detection and classification apparatus 3 according to the embodiments may be entirely hardware, or may have an aspect of being partially hardware and partially software. For example, each unit of the malicious code detection and classification apparatus 3 shown in FIG. 1 may collectively refer to hardware and related software for processing data of a specific format and content or exchanging data in an electronic communication method, and software related thereto. In the present disclosure, terms such as “unit,” “module,” “apparatus,” “terminal,” “server” or “system” are intended to refer to a combination of hardware and software driven by the hardware. For example, software-driven by hardware may refer to a running process, an object, an executable file, a thread of execution, a program, and the like.

In addition, each element constituting the malicious code detection and classification apparatus 3 is not necessarily intended to refer to a separate apparatus that is physically separated from each other. For example, the transceiver 31, the graph-generating unit 32, the matrix-generating unit 33, and the machine-learning unit 34 of FIG. 1 are only division of operations executed by the hardware of the malicious code detection and classification apparatus 3 in function, and each unit does not necessarily have to be provided independently of each other. Of course, depending on the embodiment, one or more of the transceiver 31, the graph-generating unit 32, the matrix-generating unit 33, and the machine-learning unit 34 may be implemented as separate apparatus that are physically separated from each other.

The transceiver 31 may receive source data to be analyzed by communicating with the user device 1 or the external server 2 and/or provide detection results for malicious codes. To this end, the transceiver 31 is configured to communicate with the user device 1 and/or the external server 2 through a wired or wireless communication network.

For example, the malicious code detection and classification apparatus 3 according to the embodiments can be communicated with one or more communication methods selected from the group including a Local Area Network (LAN), a Metropolitan Area Network (MAN), a Global System for Mobile Network (GSM), an Enhanced Data GSM Environment (EDGE), High-Speed Downlink Packet Access (HSDPA), Wideband Code Division Multiple Access (W-CDMA), Code Division Multiple Access), Time Division Multiple Access (TDMA), Bluetooth, Zigbee, Wi-Fi, Voice over Internet Protocol (VoIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), Wi-MAX (World Interoperability for Microwave Access)) and ultrasonic communication. but is not limited thereto.

In the present disclosure, the user device 1 is a smartphone-driven by an Android operating system (OS), and the source data to be analyzed is described by taking an APK file, which is an executable file of an app running on a smartphone using the Android OS, as an example. At this time, the external server 2 may be a server that provides an online market for downloading apps in the user device 1, such as Google Play Store, or may be a separate server for the purpose of storing the source code of the app or checking the safety of the source code.

However, this is just an example, and in the present disclosure, the source data may refer to data executable on various operating systems and is not limited to an

APK file. In addition, the user device 1 may be operated using any computer operating system such as Microsoft Windows, OS X, and Linux, or any mobile operating system such as Apple iOS and Windows Mobile.

In addition, the form of the user device 1 in the present disclosure is not limited to a smartphone, and any computing device such as a mobile communication terminal, a personal computer, a notebook computer, a personal digital assistant (PDA), a tablet, a set-top box for IPTV (Internet Protocol Television) and the like may correspond to the user device 1.

Meanwhile, in another embodiment, the malicious code detection and classification apparatus 3 itself may be implemented in a user device such as a smartphone or a personal computer. In this case, the user device 1 shown in FIG. 1 may be omitted, and the analysis target source data may be received by the malicious code detection and classification apparatus 3 from the external server 2 through a wired or wireless communication network, or may be directly input into the malicious code detection and classification apparatus 3.

The graph-generating unit 32 may generate graph information based on a relationship between application programming interfaces (APIs) included in the source data from source data received or input to the transceiver 31. That is, the graph information may include a plurality of nodes corresponding to each API included in the source data and one or more edges connecting between each node. At this time, the graph-generating unit 32 may use only call graph information in the form of plain text in the Graph Modeling Language (GML) without the need to visualize this graph information for the entire source data.

The matrix-generating unit 33 may generate an adjacency matrix between APIs included in the source data using the graph information generated by the graph-generating unit 32. In this case, the adjacency matrix may be a two-dimensional matrix, in which each row and each column of the matrix represents one API.

The machine-learning unit 34 serves to detect whether the source data is malicious code by using the adjacency matrix generated by the matrix-generating unit 33 as an input to a machine-learning-based analysis model.

To this end, in one embodiment, the machine-learning unit 34 may include a storage unit 343, in which analysis models and related parameters are stored. Also, in one embodiment, the machine-learning unit 34 may include a filter unit 341 for activating a region where respective APIs are connected to each other in the adjacency matrix. Furthermore, in one embodiment, the machine-learning unit 34 may include analysis unit 342 configured to detect malicious code by using the region activated by the filter unit 341 as an input value for the machine-learning-based analysis model.

In the following disclosure, the analysis by the machine-learning unit 34 is described by taking an example of classifying source code by applying a convolutional neural network (CNN) algorithm to an input image generated from an adjacency matrix, However, the analysis model that can be used by the malicious code detection and classification apparatus 3 according to the embodiments is not limited to CNN.

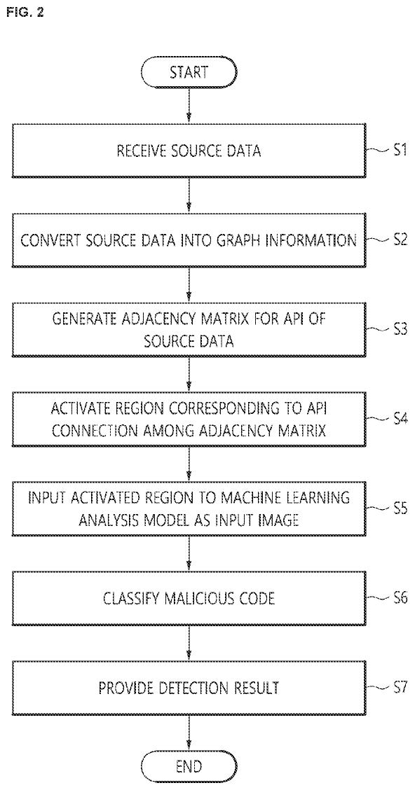

FIG. 2 is a flowchart illustrating each step of a malicious code detection and classification method according to an embodiment. For convenience of description, a malicious code detection and classification method according to the present embodiment will be described with reference to FIGS. 1 and 2.

First, the transceiver 31 of the malicious code detection and classification apparatus 3 may receive target source data for detecting malicious code therein (S1). In one embodiment, the transceiver 31 may receive source data from the user device 1 or the external server 2 in a communication method through a wired and/or wireless network. However, in another embodiment, when the malicious code detection and classification apparatus 3 itself is configured as a user device, the source data may be directly input into the malicious code detection and classification apparatus 3.

Next, the graph-generating unit 32 of the malicious code detection and classification apparatus 3 may convert the source data into graph information (S2). The graph information means that each API included in the source data is expressed as a node by analyzing the source data, and the relationship between APIs is expressed as an edge. For example, graph information may be generated using a commercial reverse engineering tool such as AndroGuard, but is not limited thereto.

In one embodiment, in order to maintain a constant size of an adjacency matrix to be generated later, graph information may be generated using only an API built into an operating system.

In generating graph information, the entire source data can be visualized as nodes and edges, but this takes a lot of time and cost. Accordingly, in one embodiment, the graph-generating unit 32 may use only call graph information, which is plain text written in a graph modeling language, as graph information. Table 1 below shows an example of graph information in the form of plain text, and shows graph information including a node having ID 62 and an edge connecting node 62 and node 2772.

TABLE 1

| | |
|---|---|
| 375 | node [ |
| 376 | id 62 |
| 377 | label ”../os/BuildCompat;->isAtLeastO( )..“ |
| 378 | entrypoint 0 |
| 379 | external 0 |
| 380 | ] |
| . . . | |
| 689 | edge [ |
| 690 | source 62 |
| 691 | target 2772 |
| 692 | ] |

Next, the matrix-generating unit 33 of the malicious code detection and classification apparatus 3 may generate an adjacency matrix for the API of the source data using the graph information (S3). An adjacency matrix represents a connection relationship between APIs by each component of the matrix. In one embodiment, the adjacency matrix means a two-dimensional matrix, in which each row and column of the matrix is an API. The matrix-generating unit 33 may generate an adjacency matrix by sequentially examining all API methods included in the source data and updating the adjacency matrix whenever an API is related to another API.

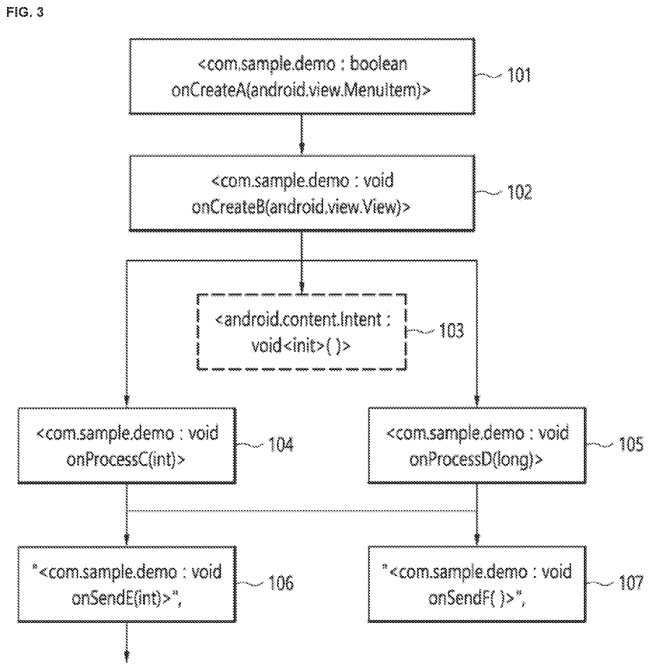

For example, FIG. 3 is a call graph showing API calls of source data analyzed by a malicious code detection and classification method according to an embodiment.

Referring to FIG. 3, in the call graph analyzing the source data in this example, the onCreateB API is called by the onCreateAAPI so that the node 102 and the node 102 are connected, and the onCreateB API is called to execute the initialization function 103. Meanwhile, the onCreateB API calls the onProcessC and onProcessD APIs, respectively, so that the node 102 is connected to the respective nodes 104 and 105 corresponding to the onProcessC and onProcessD APIs. In addition, the onProcessC API calls the onSendE API to connect node 104 to node 106, and the onProcessD API calls onSendF API to connect node 105 to node 107.

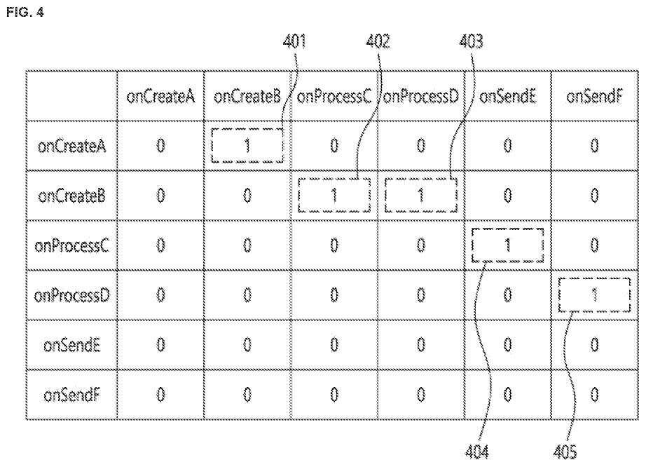

FIG. 4 is an image showing an adjacency matrix generated using the graph information shown in FIG. 3.

Referring to FIG. 4, each row of the adjacency matrix sequentially corresponds to each API of onCreateA, onCreateB, onProcessC, onProcessD, onSendE, and onSendF, and similarly, each column of the adjacency matrix sequentially corresponds to these six APIs. Therefore, in this example, the adjacency matrix has a size of 6×6. At this time, each component of the adjacency matrix represents the call relationship between APIs of the corresponding row and column. The value of the component is defined as 1 if the API corresponding to the row calls the API corresponding to the column, and the value of the component is defined as 0 if there is no such calling relationship.

In the example described above with reference to FIG. 3, since the onCreateA API corresponding to row 1 calls the onCreateB API corresponding to column 2, the value 401 of components (1, 2) of the adjacency matrix is 1. Similarly, since the onCreateB API corresponding to row 2 calls the onCreateC API and onCreateD API corresponding to columns 3 and 4, respectively, the values 402 of components (2, 3) and the values of components (2, 4) of the adjacency matrix 403 also become 1, respectively. In the same way, since the onProcessC API in row 3 calls the onSendE API in column 5, the value 404 of component (3, 5) becomes 1, and since the onProcessD API in row 4 calls the onSendF API in column 6, the value 406 of the component (4, 6) also becomes 1.

In the above manner, the connection relationship between APIs included in the source data can be converted into an adjacency matrix.

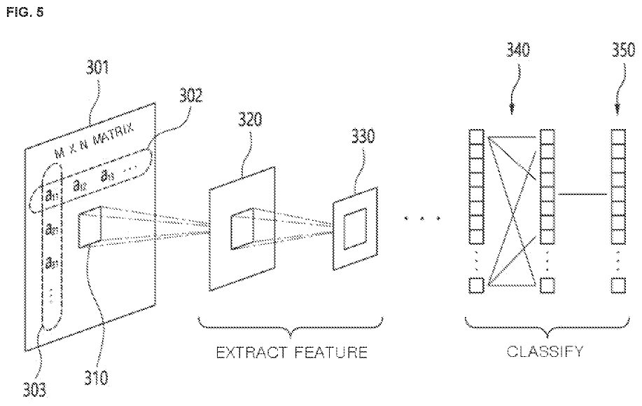

Next, the machine-learning unit 34 of the malicious code detection and classification apparatus 3 may generate a malicious code detection result for the source data by using the adjacency matrix as an input value for the machine-learning-based analysis model. Further referring to FIG. 5, the analysis result by the machine-learning unit 34 will be described in more detail.

First, the filter unit 341 of the machine-learning unit 34 may activate a region having a connection relationship between APIs among the adjacency matrix (S4). Referring to FIG. 5, the adjacency matrix 301 may be a two-dimensional matrix having m rows and n columns, where m and n may be arbitrary natural numbers and may be the same number. Each row and column of the adjacency matrix 301 corresponds to an API, for example, the first row 302 having components a11, a12, a13 . . . corresponds to a first API, and the first column 303 having components a21, a22, a23 . . . corresponds to the second API. In this case, the component all is defined by the presence or absence of a connection relationship between the first API and the second API and/or the number of connections.

At this time, the filter unit 341 may activate a region having a connection relationship between APIs in the adjacency matrix 301, and the analysis unit 342 may input the activated region 310 to a machine-learning analysis model as an input image (S5). For example, in one embodiment, the machine-learning unit 34 may detect malicious code by learning through a CNN algorithm, and in this case, the filter unit 341 may correspond to a convolution filter of the CNN.

There is a predetermined tendency in the frequency of APIs appearing in malicious code, and the machine-learning unit 34 can classify the source data by learning this. For example, Table 2 below shows the API appearance frequency in each malicious code family of BankBot, Dowgin, DroidKungfu, Fakelnst, Fusob, Kuguo, Mecor, and Youmi, and the machine-learning unit 34 may generate an analysis model by performing learning using training data, in which it is known in advance whether the code is malicious.

TABLE 2

| | Malicious Code | | | | | | | |
|---|---|---|---|---|---|---|---|---|
| | Bank | | Droid | | | | | |
| API | Bot | Dowgin | Kungfu | Fakelnst | Fusob | Kuguo | MEcor | Youmi |
| startActivity( | 4060 | 24447 | 3378 | 5064 | 475 | 9044 | 10994 | 15313 |
| setPassword( | 3339 | 12010 | 65 | 430 | 0 | 1771 | 3210 | 3748 |
| removeCallbacks( | 4261 | 6445 | 284 | 475 | 503 | 1007 | 1926 | 2066 |
| readValue( | 48 | 952 | 12 | 0 | 0 | 380 | 0 | 347 |
| onClick( | 7924 | 98537 | 15762 | 10039 | 81 | 54970 | 30959 | 97936 |
| getSystemService( | 3701 | 11786 | 1865 | 3790 | 141 | 4813 | 6744 | 5252 |
| getSharedPreferences( | 594 | 7315 | 1622 | 5041 | 32 | 4692 | 5566 | 4348 |
| setClassName( | 3909 | 15862 | 457 | 1169 | 21 | 2653 | 5351 | 4684 |
| startService( | 2637 | 6626 | 768 | 1929 | 32 | 2294 | 1820 | 1716 |
| handleMessage( | 3261 | 40647 | 2361 | 172 | 738 | 20212 | 7043 | 19944 |

Referring to FIG, 5, the filter unit 341 may sequentially activate regions having a connection relationship between APIs in the adjacency matrix 301 with a size corresponding to the input image of the CNN, and the analysis unit 342 may perform the processes of extracting a feature using the activated region 310 of the adjacency matrix 301 as an input image and classifying the feature as malicious code or non-malicious code through a neural network.

Specifically, the convolution layer 320 that extracts a feature map by performing a convolution operation with a filter on the activated region 310 of the adjacency matrix 301 and the pooling layer 330 that receives the output data of the convolution layer 320 as the input and reduces the size of output data or emphasizes specific data may be used, Although one convolution layer 320 and one pooling layer 330 are shown in the figure, the convolution layer 320 and the pooling layer 330 may be alternately used a plurality of times. When the feature values are extracted, a fully connected layer 340 is formed through a neural network, and output information 350 corresponding to a result of the classification of malicious codes can be generated from the fully connected layer 340.

Since the above process is well known to those skilled in the art from known CNN algorithms, a detailed description thereof will be omitted to clarify the gist of the invention.

The inventors trained a machine-learning analysis model using a malicious code sample operating in the Android operating system, and tested the malicious code detection performance for unknown source data using the machine-learning analysis model. Table 3 below shows the results. As an analysis feature, an adjacency matrix having 219 rows and columns, respectively, based on Android's built-in API was used, and despite a limited number of features, high accuracy was obtained as shown in the table below.

TABLE 3

| | Normal vs | Accuracy | Convergence Rate |
|---|---|---|---|
| Dataset | Malicious | (%) | (epoch) |
| BankBot | 1500 vs 648 | 99.38 | 2 |
| Dowgin | 1500 vs 3384 | 93.17 | 6 |
| DroidKungfu | 1500 vs 546 | 98.86 | 3 |
| FakeInst | 1500 vs 2172 | 98.82 | 6 |
| Fusob | 1500 vs 1277 | 97.48 | 5 |
| Kuguo | 1500 vs 1199 | 98.52 | 5 |
| Mecor | 1500 vs 1820 | 100 | 4 |
| Youmi | 1500 vs 1300 | 97.38 | 4 |

In addition, Table 4 below shows the accuracy and recall of malicious code detection results according to an embodiment of the present invention, and in the case of some malicious code families, the analysis accuracy reached 100%, indicating that the malicious code detection method according to this embodiment has superior performance compared to the prior art.

TABLE 4

| Dataset | Accuracy | Recall | F1-Point | Support |
|---|---|---|---|---|
| BankBot | 0.99 | 0.99 | 0.99 | 194 |
| Dowgin | 0.94 | 0.97 | 0.95 | 1015 |
| DroidKungfu | 0.98 | 0.99 | 0.98 | 164 |
| FakeInst | 1.00 | 1.00 | 1.00 | 652 |
| Fusob | 1.00 | 1.00 | 1.00 | 383 |
| Kuguo | 0.97 | 0.89 | 0.93 | 360 |
| Mecor | 1.00 | 1.00 | 1.00 | 546 |
| Youmi | 0.92 | 0.92 | 0.92 | 390 |
| Accuracy | | | 0.97 | 3704 |
| Macro Average | 0.97 | 0.97 | 0.97 | 3704 |
| Weighted | 0.97 | 0.97 | 0.97 | 3704 |
| Average | | | | |

Referring back to FIGS. 1 and 2, the machine-learning unit 34 of the malicious code detection and classification apparatus 3 may generate a malicious code detection result for the source data through the above process (S7). For example, the malicious code detection result may indicate whether a specific app is a malicious app or whether to publish the corresponding app in an online store.

In addition, the transceiver 31 may transmit the detection result generated by the above process to the user device 1 and/or the external server 2 (S7). However, in another embodiment, when the malicious code detection and classification apparatus 3 itself is implemented in the form of a user device, the detection result may be directly checked on the malicious code detection and classification apparatus 3.

The foregoing method has been described with reference to flowcharts presented in the drawings. For simplicity, the method is shown and described as a series of blocks, but the invention is not limited to the order of the blocks, and some blocks may occur in a different order or concurrently with other blocks than shown and described herein, and various other branches, flow paths, and sequences of blocks that achieve the same or similar results may be implemented. Also, not all blocks shown may be required for implementation of the methods described herein.

The operation by the malicious code detection and classification method according to the above-described embodiments may be at least partially implemented as a computer program and recorded on a computer-readable recording medium. The computer-readable recording medium, on which the program for implementing the operation by the malicious code detection and classification method according to the embodiments is recorded, includes all kinds of recording devices, in which computer-readable data is stored. Examples of computer-readable recording medium include ROM, RAM, CD-ROM, magnetic tape, floppy disk, and optical data storage devices. In addition, computer-readable recording medium may be distributed in computer systems connected through a network, and computer-readable codes may be stored and executed in a distributed manner. In addition, functional programs, codes, and code segments for implementing this embodiment can be easily understood by those skilled in the art to which this embodiment belongs.

The present invention has been described with reference to the embodiments shown in the drawings, but this is only exemplary, and those skilled in the art will understand that various modifications and variations of the embodiments are possible therefrom. However, such modifications should be considered within the technical protection scope of the present invention. Therefore, the technical protection scope of the present invention should be determined by the technical spirit of the appended claims.

1. An apparatus including a machine-learning unit for detecting and classifying malicious code comprising:
a graph-generating unit configured to generate graph information from source data including a plurality of nodes corresponding to APIs included in the source data and one or more edges connecting between the plurality of nodes;
a matrix-generating unit configured to generate an adjacency matrix between the APIs included in the source data using the graph information; and
a machine-learning unit configured to detect malicious code included in the source data using the adjacency matrix as an input value for a machine-learning-based analysis model.

2. The apparatus of claim 1, wherein the graph information is text data written in a graph modeling language.

3. The apparatus of claim 1, wherein the adjacency matrix is a two-dimensional matrix containing one or more columns corresponding to the API included in the source data and one or more rows corresponding to the API included in the source data.

4. The apparatus of claim 3, wherein the matrix-generating unit configured to generate the adjacency matrix by updating the adjacency matrix in response to an API that is executed as the APIs included in the source data are sequentially executed being associated with another API.

5. The apparatus of claim 3, wherein the machine-learning unit comprises,
a filter unit configured to activate a region corresponding to APIs connected to each other the adjacency matrix; and
an analysis unit configured to classify the adjacency matrix using the activated region as an input value for the machine-learning-based analysis model.

6. The apparatus of claim 5; wherein the analysis unit is further configured to perform to detect the malicious code by a convolution neural network algorithm using the activated region as an input image.

7. A method for detecting and classifying malicious code comprising:
generating, by a malicious code detection and classification apparatus, graph information from source data including a plurality of nodes corresponding to APIs included in the source data and one or more edges connecting between the plurality of nodes;
generating; by the malicious code detection and classification apparatus, an adjacency matrix between the APIs included in the source data using the graph information; and
detecting, by the malicious code detection and classification apparatus, malicious code included in the source data using the adjacency matrix as an input value for a machine-learning-based analysis model.

8. The method of claim 7, wherein the graph information is written in a graph modeling language.

9. The method of claim 7, wherein generating the adjacency matrix comprises generating, by the malicious code detection and classification apparatus, a two-dimensional matrix containing one or more columns corresponding to the API included in the source data and one or more rows corresponding to the API included in the source data.

10. The method of claim 9, wherein generating the adjacency matrix comprises updating, by the malicious code detection and classification apparatus, the adjacency matrix in response to an API that is executed as the APIs included in the source data are sequentially executed being associated with another API.

11. The method of claim 9, wherein detecting the malicious code included in the source data comprises,
activating, by the malicious code detection and classification apparatus; a region corresponding to APIs connected to each other in the adjacency matrix by a filter; and
classifying, by the malicious code detection and classification apparatus, the adjacency matrix using the activated region as an input value for the machine-learning-based analysis model.

12. The method of claim 11, wherein classifying the adjacency matrix is performed by a convolutional neural network algorithm using the activated region as an input image.

13. A computer-readable recording medium storing a computer program for executing the malicious code detection and classification method according to claim 7 combined with hardware.

14. A computer-readable recording medium storing a computer program for executing the malicious code detection and classification method according to claim 8 combined with hardware.

15. A computer-readable recording medium storing a computer program for executing the malicious code detection and classification method according to claim 9 combined with hardware.

16. A computer-readable recording medium storing a computer program for executing the malicious code detection and classification method according to claim 10 combined with hardware.

17. A computer-readable recording medium storing a computer program for executing the malicious code detection and classification method according to claim 11 combined with hardware.

18. A computer-readable recording medium storing a computer program for executing the malicious code detection and classification method according to claim 12 combined with hardware.
